(19) United States
(12) Patent Application Publication
(10) Pub. No.: US 2026/0299826 A1
(43) Pub. Date: Oct. 1, 2026

(54) HIGH-CAPACITY SOLID-STATE DRIVE WITH ADAPTIVE HANDLING FOR HIGH PRECISION DATA WRITE

(71) Applicant: Microchip Technology Incorporated, Chandler, AZ (US)

(72) Inventors: Nian Niles Yang, Mountain View, CA (US); Pitamber Shukla, San Jose, CA (US); Ramyakanth Edupuganti, San Jose, CA (US)

(73) Assignee: Microchip Technology Incorporated, Chandler, AZ (US)

(21) Appl. No.: 19/702,838

(22) Filed: Jun. 9, 2026

Related U.S. Application Data
(63) Continuation-in-part of application No. 18/956,787, filed on Nov. 22, 2024, now Pat. No. 12,704,976.
(60) Provisional application No. 63/685,935, filed on Aug. 22, 2024.

(51) Int. Cl. G06F 3/06

(52) U.S. Cl. CPC G06F 3/0655; G06F 3/0604; G06F 3/0679

(57) ABSTRACT

A method of detecting an over-programming of a memory cell during a write operation in a non-volatile memory media of a solid-state drive, and a solid-state drive with over-programming detection. When data is written to the states of the memory cell, a current last bit is routinely or selectively checked to detect an over-programming condition of the current state. An over-programming verification level may be used to check the current last bit and may be between zero and twenty-five millivolts lower than a regular programming verification level for a next first bit of the next state. When the over-programming condition is not detected, the program operation continues to write data to the next state. When the over-programming condition is detected, either the over-programmed current last bit is identified and the program operation is adjusted, or a memory block in which the over-programmed current last bit is located is retired.

### RELATED APPLICATION

The present U.S. continuation-in-part patent application is related to and claims priority benefit of an earlier-filed U.S. non-provisional patent application titled “Method of Detecting Over-Programming in a Solid-State Drive,” Ser. No. 18/956,787, filed Nov. 22, 2024, which claims the priority benefit of an even earlier-filed U.S. provisional patent application titled “Method of Detecting Over-Programming in a Solid-State Drive,” Ser. No. 63/685,935, filed Aug. 22, 2024. The entire contents of the identified earlier-filed applications are incorporated by reference as if fully set forth herein.

### FIELD

The present disclosure relates to solid-state drives and methods of implementing them, and more particularly, the various examples described herein concern a method of detecting and handling an over-programming of a memory cell during a write operation in a non-volatile memory media of a high-capacity solid-state drive with quad-or penta-level non-volatile flash memory cells, and the solid-state drive with over-programming detection and handling.

### BACKGROUND

Solid-state drives (SSD) use non-volatile memory (NVM) media (e.g., NAND-based memory media) for data storage, and typically include application-specific integrated circuit (ASIC) controllers for managing read, write, and other operations. SSDs are typically used in high-performance computing (HPC) applications, including artificial intelligence (AI), and enterprise computing data center solutions (DCS). It is generally desirable to improve the performance and reduce the cost of SSDs, but it can be difficult to do so.

This background discussion is intended to provide related information, and is not necessarily prior art.

### SUMMARY

Examples provide a method of detecting and handling an over-programming of quad-level cell (QLC) and/or penta-level cell (PLC) NAND or other memory technology during a write operation in a non-volatile memory media of an SSD, and an SSD with over-programming detection and handling. Broadly, examples employ a dynamic double verification of the lower and upper tails, or first and last bits of each state, to detect over-programming of a memory cell, wherein over-programming occurs when the upper tail, or last bit, of a current state overlaps the lower tail, or first bit, of a next state. When over-programming is detected, examples dynamically adjust the programming and read operations so that the reads of affected bits can be more precisely mapped without negatively impacting the bit error rate. More specifically, once over-programming is detected in the current state, such that the next state is compromised and data error may occur, a status bit may indicate that over-programming has occurred, and the controller may record the address and bit location in a firmware-based over-programmed bit management table. The verify (Vt) level of the next state may then be dynamically adjusted to accommodate the detected over-programming in the current state. In particular, the verify level of the next state for next-state programming may be adjusted by an amount that is equal to or slightly larger than the amount of the Vt shift of the over-programmed bits, and the read level for the next state may be adjusted for subsequent read operations. Examples advantageously improve the data reliability of the SSD by preventing data errors and data failures that could otherwise disrupt data center services.

In an example, a method of handling an over-programming of a memory cell during a write operation in an NVM media may include the following. A program operation may be performed to write data to a plurality of states of the memory cell. A current last bit of the memory cell may be checked to detect an over-programming condition of a current state of the plurality of states of the memory cell in which the current last bit is an over-programmed bit that overlaps a next state of the plurality of states of the memory cell. Based on detection of the over-programming condition, the following operations may be performed. A verification level of the next state of the plurality of states of the memory cell may be increased to accommodate the over-programming in the current state, wherein the verification level of the next state is increased by an amount that is at least equal to the amount of a Vt shift of the over-programmed bit. A read level for the next state may be increased for a subsequent read operation.

The preceding example may further include any one or more of the following features. A status bit may be set to indicate that the over-programming has occurred, and an address and a bit location of the over-programmed bit may be recorded in a firmware-based table. The next state may include a lower tail and an upper tail, and increasing the verification level of the next state may include increasing a lower verification level of the lower tail of the next state to avoid the over-programmed bit overlapping the next state. An upper verification level of the upper tail of the next state may be left unchanged, or increasing the verification level of the next state may further include increasing the upper verification level of the upper tail of the next state. The method may further include increasing the verification level of one or more subsequent states beyond the next state. The verification level of the next state may be increased by between twenty-five (25) and one hundred (100) millivolts. Additionally or alternatively, the method may further include using a smaller program pulse time between fifty microseconds (50μs) and one hundred microseconds (100μs) for a subsequent program operation involving the memory cell. The NVM media may be a NAND-based NVM media. The NAND-based NVM media may include at least quad-level cells with four bits per cell. The NAND-based NVM media may be part of solid-state drive.

In another example, a method of handling an over-programming of a memory cell during a write operation in an NVM media, wherein the NAND-based non-volatile memory media includes at least quad-level cells with four bits per cell, may include the following steps. A program operation may be performed to write data to a plurality of states of the memory cell. A current last bit of the memory cell may be checked to detect an over-programming condition of a current state of the plurality of states of the memory cell in which the current last bit overlaps a next state of the plurality of states of the memory cell, wherein the next state includes a lower tail and an upper tail. Based on the detection of the over-programming condition, the following operations may be performed. A status bit may be set to indicate that over-programming has occurred, and an address and a bit location of the over-programmed bit may be recorded in a firmware-based table. A lower verification level of the lower tail of the next state of the plurality of states of the memory cell may be increased by between twenty-five (25) and one hundred (100) millivolts to avoid the over-programmed bit overlapping the next state, while an upper verification level of the upper tail of the next state may be left unchanged. A read level for the next state for a subsequent read operation may be increased.

In another example, an SSD configured to handle an over-programming of a memory cell during a write operation in a NAND-based NVM media, wherein the NAND-based NVM media includes at least quad-level cells with four bits per cell, may include a NAND-based NMV media and a controller. The NAND-based NMV media may be configured to store data, and the controller may be configured to perform the following functions involving the data. A program operation may be performed to write data to a plurality of states of the memory cell. A current last bit of the memory cell may be checked to detect an over-programming condition of a current state of the plurality of states of the memory cell in which the current last bit is an oper-programmed bit and overlaps a next state of the plurality of states of the memory cell, wherein the next state includes a lower tail and an upper tail. Based on the detection of the over-programming condition, the following operations may be performed. A status bit may be set to indicate that over-programming has occurred, and an address and a bit location of the over-programmed bit may be recorded in a firmware-based table. A lower verification level of the lower tail of the next state of the plurality of states of the memory cell may be increased by between twenty-five (25) and one hundred (100) millivolts to avoid the over-programmed bit overlapping the next state, while an upper verification level of the upper tail of the next state may be left unchanged. A read level for the next state for a subsequent read operation may be increased.

In another example, a method of detecting an over-programming of a memory cell during a write operation in an NVM media of an SSD may include the following steps. A program operation may be performed to write data to a plurality of states of the memory cell. A current last bit of the memory cell may be checked to detect an over-programming condition of a current state of the plurality of states of the memory cell in which the current last bit overlaps a next state of the plurality of states of the memory cell. Based on the detection of the over-programming condition, the over-programmed current last bit may be identified and the program operation may be adjusted to use a smaller program pulse voltage step size, of, e.g., four-tenths volt (0.4 V) or two-tenths volt (0.2 V), for a subsequent program, or write, operation involving the memory cell. Additionally or alternatively, the method may further include using a smaller program pulse time between fifty microseconds (50μs) and one hundred microseconds (100μs) for a subsequent program operation involving the memory cell. Alternatively, a memory block in which the over-programmed current last bit is located may be retired.

In another example, an SSD with over-programming detection of a memory cell during a write operation may include an NVM media and a controller. The NVM media may be configured to store data, and the controller may be configured to perform the following functions. A program operation may be performed to write data to a plurality of states of the memory cell. A current last bit of the memory cell may be checked to detect an over-programming condition of a current state of the plurality of states of the memory cell in which an over-programmed current last bit overlaps a next state of the plurality of states of the memory cell. The program operation may continue to write data to the next state when the over-programming condition is not detected. One of the following operations may be performed when the over-programming condition is detected. The over-programmed current last bit may be identified and the program operation may be adjusted to use a smaller program pulse voltage step size, of, e.g., four-tenths volt (0.4 V) or two-tenths volt (0.2 V), for a subsequent program operation involving the memory cell. Additionally or alternatively, the method may further include using a smaller program pulse time between fifty microseconds (50 μs) and one hundred microseconds (100 μs) for a subsequent program operation involving the memory cell. Alternatively, a memory block in which the over-programmed current last bit is located may be retired.

The preceding additional examples may further include any one or more of the following features (to the extent such features are not already included). The NAND-based non-volatile memory media may be part of a solid-state drive. The NAND-based non-volatile memory media may include at least penta-level cells. The NVM media may be a NAND-based memory media. A smaller program pulse time between fifty microseconds (50μs) and one hundred microseconds (100μs) may be used for a subsequent program operation involving the memory cell. Identifying the over-programmed current last bit may include recording an address and a bit location for the over-programmed current last bit, and recording a temperature for the program operation at which the over-programming condition occurred. An over-programming verification level used to check the current last bit of the memory cell to detect the over-programming condition of the current state may be identical to or lower (e.g., between one (1) and one hundred fifty (150) millivolts lower, depending on the number of bits stored per cell) than a regular programming verification level used to check a next first bit of the next state of the plurality of states of the memory cell. Checking the current last bit of the memory cell to detect the over-programming condition of the current state may be selectively performed when the memory cell is determined to have been subjected to a higher rate of program and erase cycles than an established standard rate of program and erase cycles, or when the program operation is determined to be occurring at a lower temperature than an established standard temperature. The method operations or the controller functions may further include performing a read operation to read data from the plurality of states of the memory cell, and adjusting the read operation for the over-programmed current last bit to compensate for the over-programming condition.

This summary is not intended to identify essential features of the examples, and is not intended to be used to limit the scope of the claims. These and other aspects of the present examples are described below in greater detail.

### DRAWINGS

Examples are described in detail below with reference to the attached drawing figures, wherein:

FIG. 1 presents depictions of memory cell states for tri-level cells (TLC), QLC, and penta-level cells (PLC), showing that the potential for over-programming increases as the number of bits per cell increases and the gap between tails decreases;

FIG. 2 is a high-level block diagram of components and operations of an SSD with over-programming detection of a memory cell during a write operation in an NVM media of the SSD;

FIG. 3 is a depiction of programming of a memory cell of an SSD without over-programming such that bits belonging to a current state do not overlap with a next state;

FIG. 4 is a depiction of programming of a memory cell of an SSD with over-programming such that bits belonging to the current state do overlap with the next state;

FIG. 5 is a depiction of an example of an over-programming verify operation for the current state;

FIG. 6 is a depiction of a first example of an over-programming handling operation for the next state;

FIG. 7 is a depiction of a second example of an over-programming handling operation for the next state;

FIG. 8 is a flowchart of operations in an example of a method of detecting an over-programming of a memory cell during a write operation in an NVM media of an SSD; and

FIG. 9 is a flowchart of operations in an example of a method of implementing the first and second examples of over-programming handling operations of FIGS. 6 and 7.

The figures are not intended to limit the examples to the specific details depicted. The drawings are not necessarily to scale.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, procedural, operational, and other changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, any similarity in numbering does not necessarily mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

Data centers employ large numbers of SSDs that are under constant workload for data center customers. The reliability and stability of each SSD depends on the quality of the data in its multi-level cell NVM. When these multi-level cells, such as triple-level cell (TLC), quad-level cell (QLC), and penta-level cell (PLC) NAND flash, are programmed, a program verify (PGMV) operation is performed to ensure that the cells have been successfully programmed to the targeted state. Over-programming occurs when a cell that is supposed to be programmed to, e.g., state X, is programmed to state Y or even Z. Over-programming can result from a decreasing margin between the programming states, which can lead to data error, such as cross-page failures that cannot be fixed by soft-bit reading (SBR). Conventionally, NAND programming is subject to single verification, so an over-programmed cell may pass the conventional programming verification for state X, but it may cause a state Y or Z read error. Currently, there is no effective way to handle over-programming and its impact on SSD data integrity.

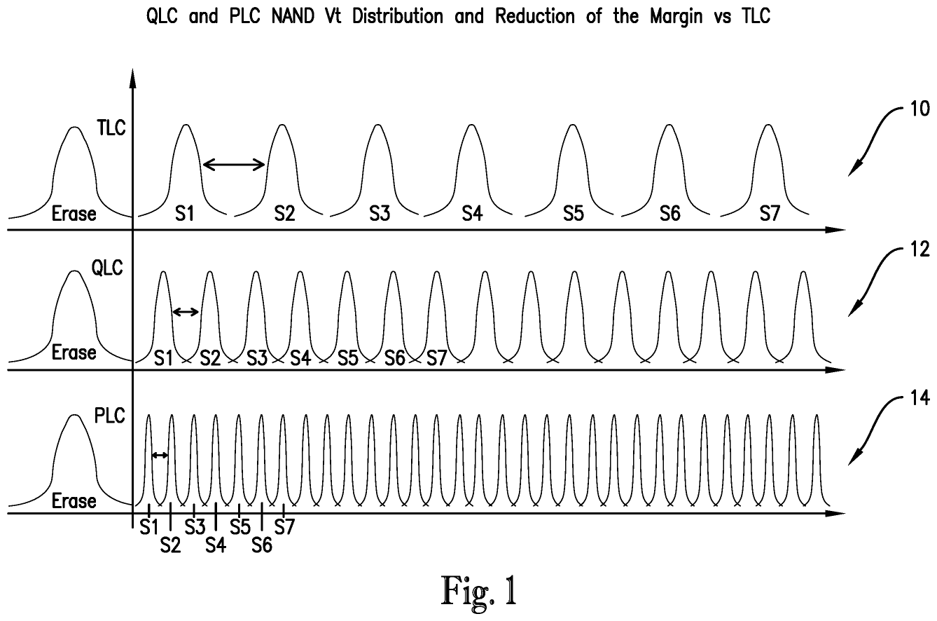

Examples of the present disclosure provide a method of detecting and handling an over-programming of a QLC (four (4) bits per cell) or PLC (five (5) bits per cell) NAND or other non-volatile flash memory cell technology during a write, or program, operation in an NVM media of an SSD and preventing hard-decoding due to over-programming, and an SSD with over-programming detection and handling. As seen in FIG. 1, which includes depictions of memory cell states for TLC 10, QLC 12, and PLC 14, the potential for over-programming increases as the number of bits per cell increases and the gap between tails decreases. More specifically, examples employ a dynamic double verification of the lower and upper tails, or first and last bits of each state, to detect over-programming of a memory cell, wherein over-programming occurs when the upper tail, or last bit, of a current state overlaps the lower tail, or first bit, of a next state. Examples advantageously improve the data reliability of the SSD by preventing data errors and data failures that could otherwise disrupt data center services. Further, examples advantageously allow for monitoring the SSD's behavior as it ages and adjusting the verification process as appropriate. Applicable industries include hyper-scale DCSs with high-capacity SSDs using QLC/PLC NAND devices, and data processing for artificial intelligence.

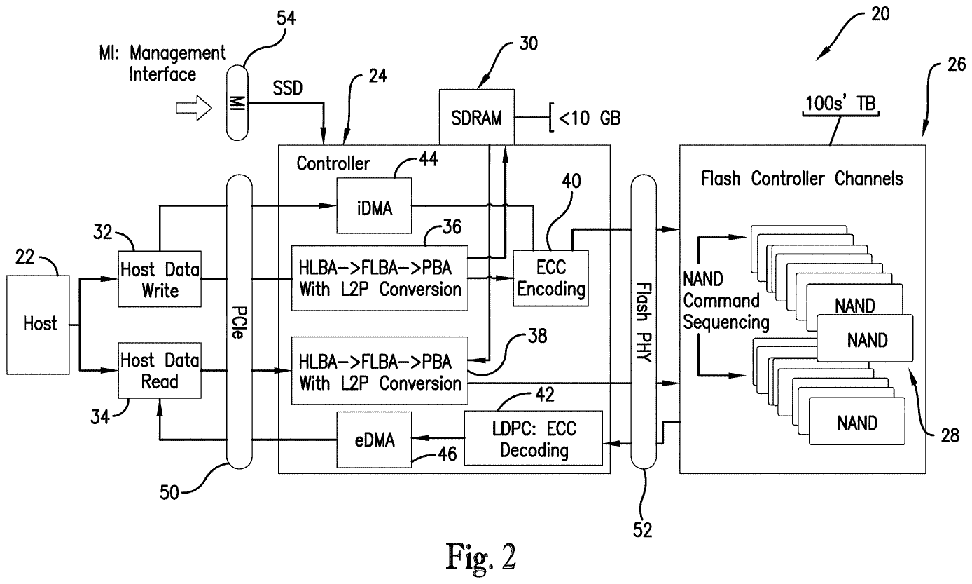

Referring to FIG. 2, a high-level block diagram of components, operations, and an operating context of an SSD 20 is shown including a host 22 configured to write and read data to and from the SSD 20; a controller 24 configured to control various SSD operations, such as those discussed below; and an NVM media 26, such as a NAND-based memory media in the form of a plurality of NAND dies 28. Each NAND die 28 may include one or more planes, each plane may include multiple blocks, each block may include multiple pages, and each page may include multiple cells. Each block may be arranged as an array of wordlines (WLs) and bitlines (BLs), with each WL representing a page. Although described herein with regard to NAND-based memory media, examples may employ substantially any suitable memory array technology, such as NOR-based memory media and dynamic random access memory (DRAM).

Generally, the SSD 20 may operate as follows. A write or read request may be received from the host 22 via a peripheral component interconnect express (PCIe) or other suitable interface 50. PCIe is a standardized interface for motherboard components. The controller 24 may use logical block addresses (LBAs) and physical block addresses (PBAs) to facilitate access for data storage in and retrieval from the NVM 26. LBAs are an abstraction to allow the operating system to interact with the NVM 26, and PBAs represent the actual hardware locations within the NVM 26. To facilitate interacting with the NVM 26, the controller 24 may create an entry or record that assigns an LBA to a PBA. To keep track of all such LBA-to-PBA assignments, the controller 24 may use a logical-to-physical (L2P) mapping table. The L2P table may be uploaded to synchronous dynamic random access memory (SDRAM) 30 so that it can be more quickly accessed and updated by the controller 24. When a write or read data request 32, 34 is received from the host 22, the controller 24 performs a reference operation 36, 38 to the L2P mapping table to determine the PBA within the NVM 26 corresponding to a desired LBA. Once the PBA is determined, the controller 24 accesses the appropriate NVM cell to write or read the data.

Access to the NVM 26 may be via a flash physical (PHY) or other suitable interface 52. The controller 24 may employ an error correction code (ECC) operation 40, 42 during encoding and decoding of data to detect and correct errors and enhance data integrity. Additionally, the SSD 20 may support a direct memory access (DMA) operation 44, 46 enabling data to be written from the host 22 directly to the NVM 26 and read from the NVM 26 directly to the host 22. Certain commands, such as the disablement commands described herein, may be issued to the controller 24 using the host command layer, or non-volatile memory express management (NVMe-MI) or other suitable interface 54.

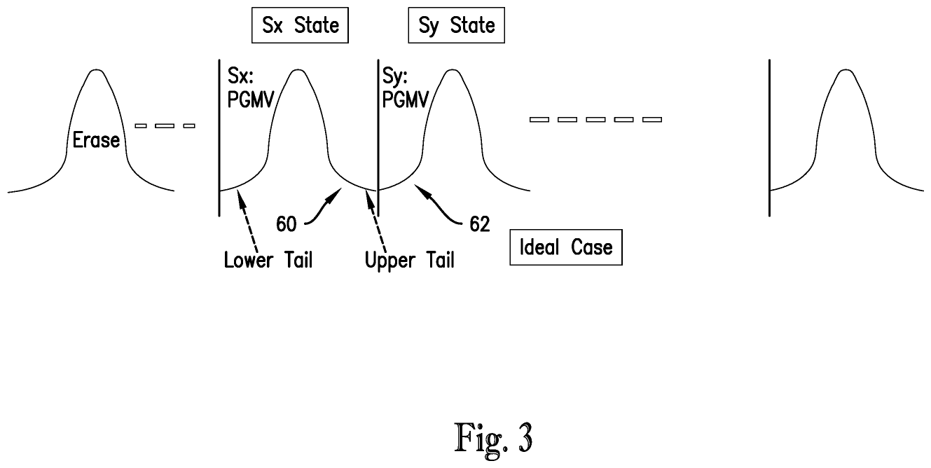

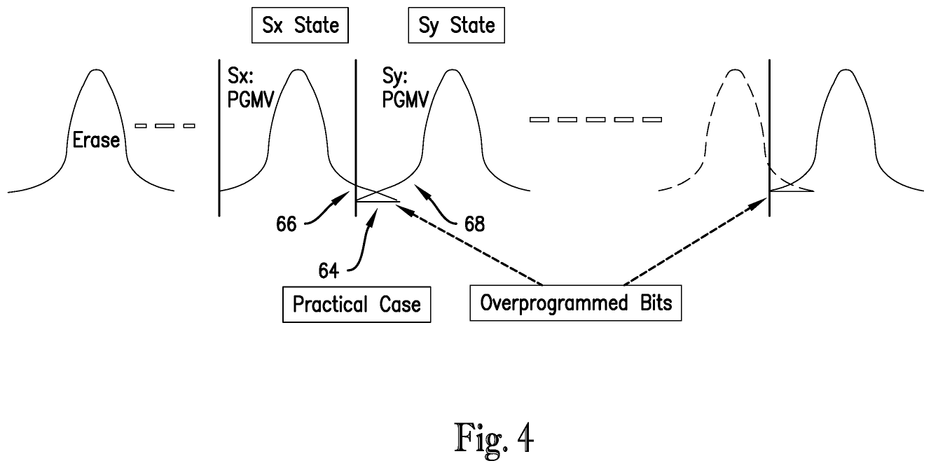

Referring to FIG. 3, the programming of an NVM cell is shown without over-programming, which is evident from the lack of overlap between the upper tail 60, or last bit, of the current Sx state and the lower tail 62, or first bit, of the next Sy state. Referring also to FIG. 4, the programming of an NVM cell is shown with over-programming, which is evident from the overlap 64 between the upper tail 66, or last bit, of the current Sx state and the lower tail 68, or first bit, of the next Sy state. Ideally, Sx and Sy are programmed so that they do not overlap after programming, as seen in FIG. 3. In more detail, on these graphs of the number of bits (y axis) versus the threshold voltage (Vt) (x axis), the states, S, of multiple cells, Sx, Sy, and Sz, are associated with increasing Vt (indicated by the vertical lines between states). Each state is represented by a Gaussian distribution with a lower tail and an upper tail. In the ideal case, seen in FIG. 3, the upper tail of one state does not cross the Vt of, or overlap into, the next state, while in the case of overprogramming, seen in FIG. 4 and discussed below, the upper tail of one state does cross the Vt of, or overlap into, the next state.

In actual practice, over-programming of the NVM cell, as seen in FIG. 4, may occur as follows. After a cell passes the conventional lower-tail program verification, the BL for that cell may be inhibited so that the bit cannot be further programmed. However, the fast bits may have already been bumped into the next states, such as the Sy or even the Sz state. Due to a statistically and physically unavoidable fast bit behavior of the NVM cells, some bits tend to respond faster to the programming pulse, which results in over-programming in which bits belonging to the Sx state move into and overlap with the Sy state. These over-programmed bits can still pass the conventional lower-tail Sx program verification but they are nonetheless erroneous as the upper-tail is beyond the Sy verify level. Because different states belong to different pages on a WL, an over-programmed state that overlaps with the next state creates a hard error during the read operation that can cause a read ECC decoding failure. This over-programming behavior is dependent on both program/erase (P/E) cycle and temperature. In particular, the higher the PEC of the NAND, the more the bits may be over-programmed. Further, under otherwise similar programming conditions, programming at lower temperatures tends to be weaker and the program may use more pulses, while programming at higher temperatures results in the threshold voltage (Vt) appearing to be higher.

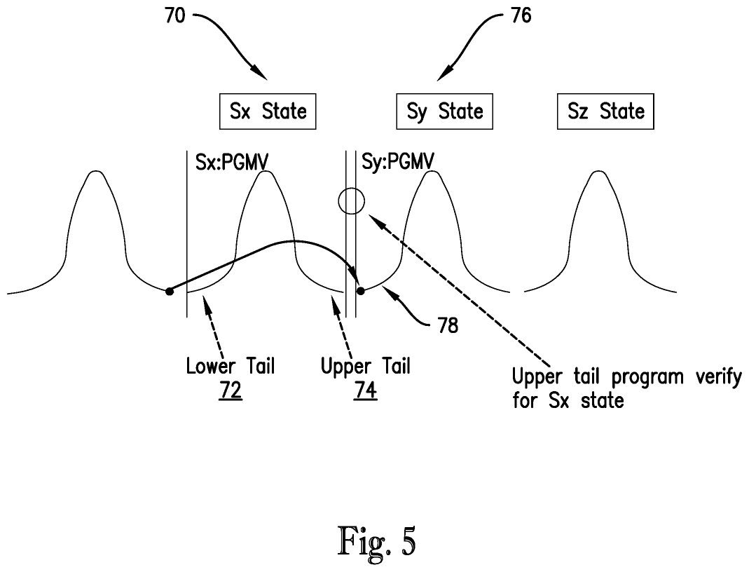

Referring to FIG. 5, examples enable the SSD 20 to detect an over-programming of a NAND memory cell in the NVM media 26 and prevent hard-decoding due to over-programming. Some or all of the functions of the SSD 20 may be reflected in the operations of the method 120 described below. Following a NAND program operation of a current Sx state 70, examples perform a dynamic double verification operation to verify both the lower Sx tail 72, or first current bit, and to verify that the upper Sx tail 74, or last current bit, does not overlap the next Sy state 76. This dynamic double verification operation may be performed after the Sx state programming has been completed. The upper tail verification level can be either the Sy state program verification level (for the lower Sy tail 78) or lower than that, by, e.g., twenty-five (25) millivolts (mV) for PLCs that store five bits per cell or up to one hundred fifty (150) mV for larger cells, which can be controlled by the controller 24 through the NAND parameter setting. Thus, although the issue involves the NVM 26, the setting of the parameter for the operation can be controlled by the controller or by firmware.

The controller 24 may identify and address any over-programmed bits for decoding purposes to avoid hard decoding failures. This may be accomplished as follows. As part of the over-program handler, the controller 24 may create a firmware-based over-programmed bit table containing the locations of detected over-programming bits. When the host 22 requests to read-out data that includes an over-programmed bit identified in the table, the controller 24 may correct the over-programmed bit inside the data frame before it is decoded. Further, the temperature and P/E cycle at which the over-programming occurs may also be recorded in the over-programmed bit table so that the next program cycle at the same or lower temperature may be weaker (e.g., smaller steps with more frequent program verify). Alternatively, if a block exhibits over-programming then the system may elect to retire the block for data security (similar to the program failure operation).

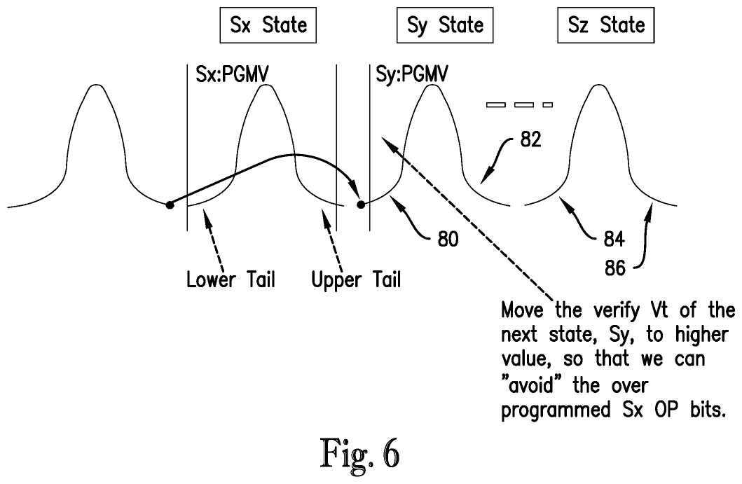

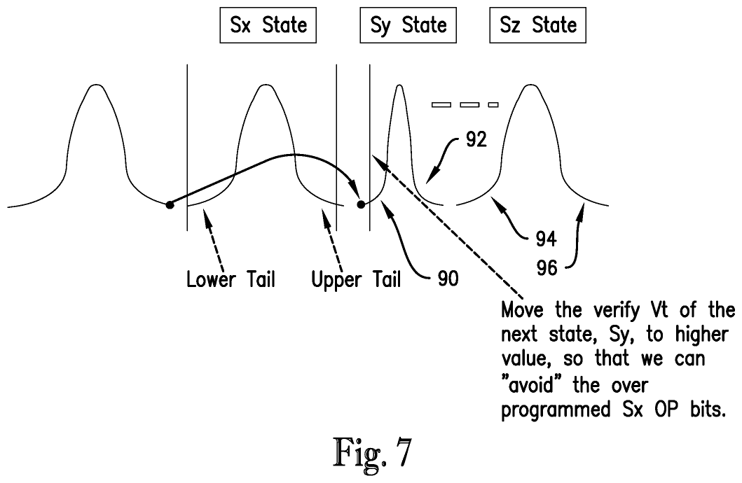

Referring to FIGS. 6 and 7, examples further enable the SSD 20 to handle a detected over-programming of a NAND memory cell in the NVM media 26 and prevent hard-decoding due to over-programming. Some or all of the functions of the SSD 20 may be reflected in the operations of the method described below. The states Sx, Sy, Sz, include upper and lower tails. Based on detection of over-programming of a current Sx state, the controller 24 may perform the following operations. A status bit may be set to indicate that over-programming has occurred, and an address and a bit location of the over-programmed bit may be recorded in a firmware-based table stored in electronic memory. A verification level of the next state (Sy) of the plurality of states of the memory cell may be increased to accommodate the detected over-programming in the current (Sx) state. The verification level of the next state may be increased by an amount that is at least equal to the amount of a voltage threshold (Vt) shift of the over-programmed current last bit. A read level for the next (Sy) state may be increased for a subsequent read operation.

Referring particularly to FIG. 6, a first example of an over-programming handling operation for the next state is shown involving the following operations. Increasing the verification level of the next (Sy) state may include increasing a lower verification level of the lower tail 80 of the next (Sy) state to avoid the current last bit overlapping the next (Sy) state, and may further include increasing an upper verification level of the upper tail 82 of the next (Sy) state. Additionally, the first example may further include increasing the upper and lower verification levels 84, 86 of one or more subsequent (Sz) states beyond the next (Sy) state to accommodate the increased upper verification of the upper tail 82 of the next (Sy) state. In effect, the next and subsequent states are all shifted to compensate for over-programming the current (Sx) state. The lower and upper verification levels of the lower and upper tails 80, 82 of the next state (Sy) of the plurality of states of the memory cell, and of any subsequent (Sz) states, may be increased by between twenty-five (25) and one hundred (100) millivolts to avoid the current last bit overlapping the next (Sy) state.

Referring particularly to FIG. 7, a second example of an over-programming handling operation for the next state is shown involving the following operation. Increasing the verification level of the next (Sy) state may include increasing only a lower verification level of the lower tail 90 of the next (Sy) state to avoid the current last bit overlapping the next (Sy) state, while leaving unchanged the upper verification level of the upper tail 92 of the next (Sy) state. In this second example, the verification levels 94, 96 of one or more subsequent (Sz) states beyond the next (Sy) state do not need to be changed because the upper verification of the upper tail 92 of the next (Sy) state is unchanged. In effect, the next (Sy) state is compacted to fit within the over-programmed current (Sx) state and the subsequent (Sz) state. The lower verification level of the lower tail 90 of the next state (Sy) of the plurality of states of the memory cell may be increased by between twenty-five (25) and one hundred (100) millivolts to avoid the current last bit overlapping the next (Sy) state. Over-programming detection may be performed routinely or selectively. In particular, over-programming is an exception event that should not occur often, so if a randomly selected location does not exhibit over-programming, then for the particular P/E cycle, there may be no need to conduct further over-programming detection operations. Additionally, selective over-programming detection may also be based on such factors as collected data about the SSD, such as the NAND characterization during the die sort and wafer sort, and on a failure signature due to over-programming during a drive qualification.

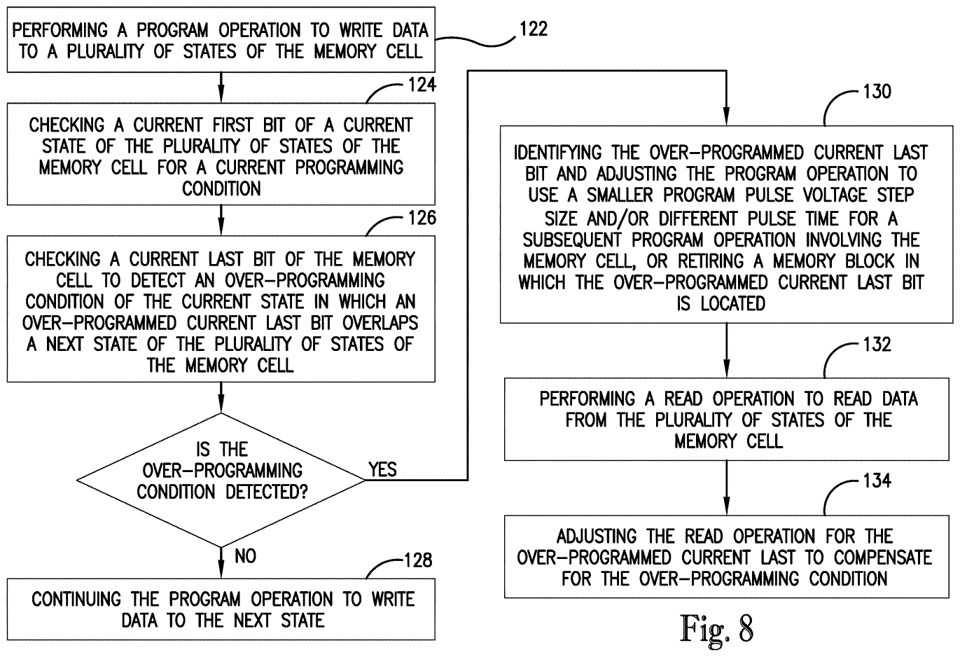

Referring to FIG. 8, an example of a method 120 of implementing the first example of the over-programming handling operation of FIG. 6 may include the operations set forth below. The SSD 20 may include a controller 24 and the NAND-based or other NVM media 26. Some or all of the operations of the method 120 may be reflected in the functions of the SSD 20 described above. A program operation may be performed to write data to a plurality of states of the memory cell, as shown in 122. A regular program verify operation may be performed involving checking a current first bit (e.g., the lower Sx tail 72) of a current state of the plurality of states of the memory cell for a current programming state, as shown in 124.

A current last bit (e.g., the upper Sx tail 74) of the memory cell may be checked to detect an over-programming condition of the current state in which an over-programmed current last bit overlaps a next first bit (e.g., the lower Sy tail 78) of the next state of the plurality of states of the memory cell, as shown in 126 and seen in FIG. 4. An over-programming verification level for the current last bit of the memory cell to detect an over-programming condition of the current state may be identical to or lower (e.g., between one (1) mV and twenty-five (25) mV lower for PLC, or between one (1) mV and one hundred fifty (150) mV for larger cells) than a regular programming verification level for a next first bit of the next state of the plurality of states of the memory cell. Over-programming detection may be performed routinely or selectively. In particular, over-programming detection may be selectively performed when the memory cell is determined to have been subject to a higher rate of P/E cycles than an established standard rate of P/E cycles, or when the program operation is determined to be occurring at a lower temperature than an established standard temperature.

If an over-programmed condition is not detected, the program operation may continue to write data to the next state, as shown in 128. However, if the over-programmed condition is detected, wherein an over-programmed bit can cause a hard read error that cannot be decoded even with a soft bit read, then the over-programmed current last bit may be identified and the program operation may be adjusted to use a smaller program pulse voltage step size, of, e.g., four-tenths volt (0.4 V) or two-tenths volt (0.2 V), for a subsequent program operation involving the memory cell, as shown in 130. Additionally or alternatively, a smaller program pulse time between fifty microseconds (50 μs) and one hundred microseconds (100 μs) may be used for a subsequent program operation involving the memory cell, as also shown in 130. Identifying the over-programmed bit may include recording an address and a bit location for the over-programmed current last bit, and recording a temperature for the program operation at which the over-programmed condition occurred. Alternatively, the memory block in which the over-programmed last bit is located may be retired (which can be treated as a programming failure), as also shown in 130, and the retired block may be handled accordingly.

The method 120 may further include performing a subsequent read operation to read data from the plurality of states of the memory cell, as shown in 132, and adjusting the read operation for the over-programmed current last bit to compensate for the over-programming condition, as shown in 134.

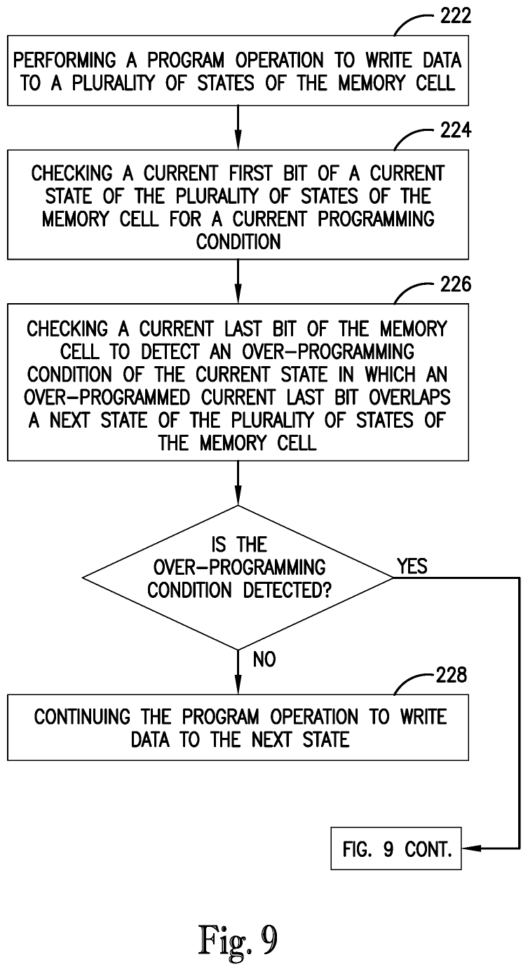

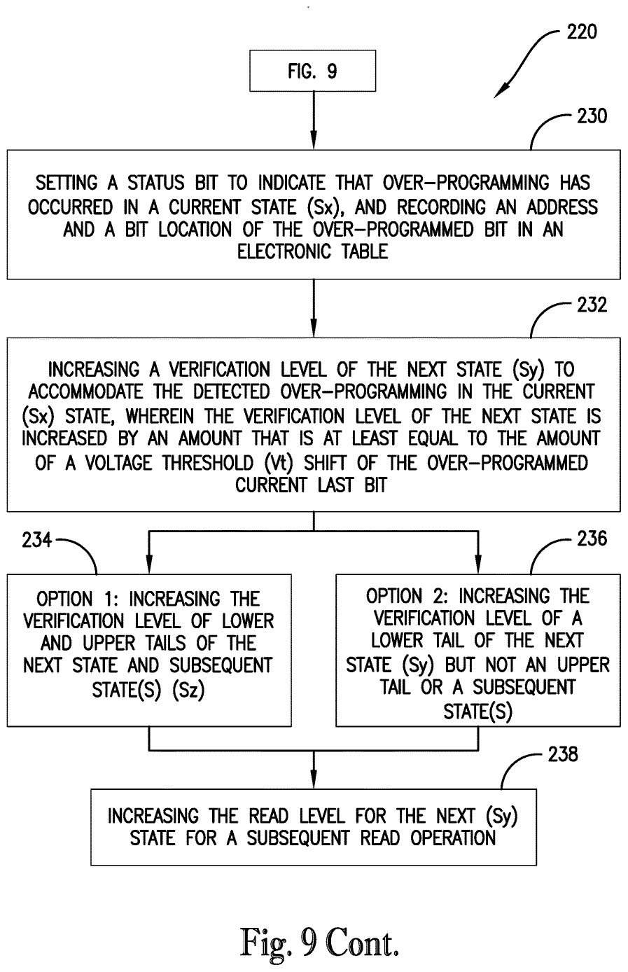

Referring to FIG. 9, an example of a method 220 of implementing the second example of the over-programming handling operations of FIG. 7 may include the operations set forth below. The SSD 20 may include a controller 24 and the NAND-based or other NVM media 26. Some or all of the operations of the method 220 may be reflected in the functions of the SSD 20 described above. A program operation may be performed to write data to a plurality of states of the memory cell, as shown in 222. A regular program verify operation may be performed involving checking a current first bit (e.g., the lower Sx tail 72) of a current state of the plurality of states of the memory cell for a current programming state, as shown in 224. A current last bit (e.g., the upper Sx tail 74) of the memory cell may be checked to detect an over-programming condition of the current state in which an over-programmed current last bit overlaps a next first bit (e.g., the lower Sy tail 78) of the next state of the plurality of states of the memory cell, as shown in 226 and seen in FIG. 4. An over-programming verification level for the current last bit of the memory cell to detect an over-programming condition of the current state may be identical to or lower (e.g., between one (1) mV and twenty-five (25) mV lower for PLC, or between one (1) mV and one hundred fifty (150) mV for larger cells) than a regular programming verification level for a next first bit of the next state of the plurality of states of the memory cell. Over-programming detection may be performed routinely or selectively.

If an over-programmed condition is not detected, the program operation may continue to write data to the next state, as shown in 228. However, if the over-programmed condition is detected, wherein an over-programmed bit can cause a hard read error that cannot be decoded even with a soft bit read, then over-programming handling may be performed as follows.

The states Sx, Sy, Sz, include upper and lower tails. Based on detection of over-programming of a current Sx state, the controller 24 may perform the following operations. A status bit may be set to indicate that over-programming has occurred, and an address and a bit location of the over-programmed bit may be recorded in a firmware-based table stored in electronic memory, as shown in 230. A verification level of the next state (Sy) of the plurality of states of the memory cell may be increased to accommodate the detected over-programming in the current (Sx) state, as shown in 232. The verification level of the next state may be increased by an amount that is at least equal to the amount of a voltage threshold (Vt) shift of the over-programmed current last bit.

A first example of an over-programming handling operation, which is also the subject of FIG. 6, may include the following operations. Increasing the verification level may include increasing a lower verification level of the lower tail of the next (Sy) state to avoid the current last bit overlapping the next state, increasing an upper verification level of the upper tail of the next (Sy) state, and increasing the verification levels of one or more subsequent (Sz) states beyond the next (Sy) state to accommodate the increased upper verification of the upper tail of the next (Sy) state, as shown in 234. In effect, the next and subsequent states are all shifted to compensate for over-programming the current (Sx) state. The lower and upper verification levels of the lower and upper tails of the next state (Sy) of the plurality of states of the memory cell, and of any subsequent (Sz) states, may be increased by between twenty-five (25) and one hundred (100) millivolts to avoid the current last bit overlapping the next (Sy) state. A read level for the next (Sy) state may be increased for a subsequent read operation, as shown in 238.

A second example of an over-programming handling operation, which is also the subject of FIG. 7, may include the following operations. Increasing the verification level may include increasing only a lower verification level of the lower tail of the next (Sy) state to avoid the current last bit overlapping the next state, while leaving unchanged the upper verification level of the upper tail of the next (Sy) state and the verification levels of one or more subsequent (Sz) states, as shown in 236. In effect, the next (Sy) state is compacted to fit within the over-programmed current (Sx) state and the subsequent (Sz) state. The lower verification level of the lower tail of the next state (Sy) of the plurality of states of the memory cell may be increased by between twenty-five (25) and one hundred (100) millivolts to avoid the current last bit overlapping the next (Sy) state. A read level for the next (Sy) state may be increased for a subsequent read operation, as shown in 238.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

1. A method of handling an over-programming of a memory cell during a write operation in a non-volatile memory media, the method comprising:
performing a program operation to write data to a plurality of states of the memory cell;
checking a current last bit of the memory cell to detect an over-programming condition of a current state of the plurality of states of the memory cell in which the current last bit is an over-programmed bit that overlaps a next state of the plurality of states of the memory cell; and
based on detection of the over-programming condition, performing the following operations—
(a) increasing a verification level of the next state of the plurality of states of the memory cell to accommodate the over-programming in the current state, wherein the verification level of the next state is increased by an amount that is at least equal to the amount of a voltage threshold shift of the over-programmed bit, and
(b) increasing a read level for the next state for a subsequent read operation.

2. The method of claim 1, further including setting a status bit to indicate that the over-programming has occurred, and recording an address and a bit location of the over-programmed bit in a firmware-based table.

3. The method of claim 1, wherein the next state includes a lower tail and an upper tail, and increasing the verification level of the next state includes increasing a lower verification level of the lower tail of the next state to avoid the over-programmed bit overlapping the next state.

4. The method of claim 3, wherein an upper verification level of the upper tail of the next state is left unchanged.

5. The method of claim 3, wherein increasing the verification level of the next state further includes increasing an upper verification level of the upper tail of the next state.

6. The method of claim 5, further including increasing the verification level of one or more subsequent states beyond the next state.

7. The method of claim 1, wherein the verification level of the next state is increased by between twenty-five (25) and one hundred (100) millivolts.

8. The method of claim 1, further including using a smaller program pulse time between fifty microseconds (50μs) and one hundred microseconds (100μs) for a subsequent program operation involving the memory cell.

9. The method of claim 1, wherein the non-volatile memory media includes at least penta-level cells.

10. The method of claim 1, wherein the non-volatile memory media is a NAND-based non-volatile memory media.

11. The method of claim 10, wherein the NAND-based non-volatile memory media includes at least quad-level cells with four bits per cell.

12. The method of claim 11, wherein the NAND-based non-volatile memory media is part of a solid-state drive.

13. A method of handling an over-programming of a memory cell during a write operation in a NAND-based non-volatile memory media, wherein the NAND-based non-volatile memory media includes at least quad-level cells with four bits per cell, the method comprising:
performing a program operation to write data to a plurality of states of the memory cell;
checking a current last bit of the memory cell to detect an over-programming condition of a current state of the plurality of states of the memory cell in which the current last bit is an over-programmed bit that overlaps a next state of the plurality of states of the memory cell, wherein the next state includes a lower tail and an upper tail; and
based on detection of the over-programming condition, performing the following operations
(a) setting a status bit to indicate that the over-programming has occurred, and recording an address and a bit location of the over-programmed bit in a firmware-based table,
(b) increasing a lower verification level of the lower tail of the next state of the plurality of states of the memory cell by between twenty-five (25) and one hundred (100) millivolts to avoid the over-programmed bit overlapping the next state, while leaving unchanged an upper verification level of the upper tail of the next state, and
(c) increasing a read level for the next state for a subsequent read operation.

14. The method of claim 13, further including using a smaller program pulse time between fifty microseconds (50 μs) and one hundred microseconds (100 μs) for a subsequent program operation involving the memory cell.

15. The method of claim 13, wherein the NAND-based non-volatile memory media includes at least penta-level cells.

16. The method of claim 13, wherein the NAND-based non-volatile memory media is part of a solid-state drive.

17. A solid-state drive configured to handle an over-programming of a memory cell during a write operation in a NAND-based non-volatile memory media, wherein the NAND-based non-volatile memory media includes at least quad-level cells with four bits per cell, the solid-state drive comprising:
the NAND-based non-volatile memory media configured to store data; and
a controller configured to perform a plurality of functions involving the data, including—
performing a program operation to write data to a plurality of states of the memory cell;
checking a current last bit of the memory cell to detect an over-programming condition of a current state of the plurality of states of the memory cell in which the current last bit is an over-programmed bit that overlaps a next state of the plurality of states of the memory cell, wherein the next state includes a lower tail and an upper tail; and
based on detection of the over-programming condition, performing the following operations—
(a) setting a status bit to indicate that the over-programming has occurred, and recording an address and a bit location of the over-programmed bit in a firmware-based table,
(b) increasing a lower verification level of the lower tail of the next state of the plurality of states of the memory cell by between twenty-five (25) and one hundred (100) millivolts to avoid the over-programmed bit overlapping the next state, while leaving unchanged an upper verification level of the upper tail of the next state, and
(c) increasing a read level for the next state for a subsequent read operation.

18. The solid-state drive of claim 17, further including using a smaller program pulse time between fifty microseconds (50 μs) and one hundred microseconds (100 μs) for a subsequent program operation involving the memory cell.

19. The solid-state drive of claim 17, wherein the NAND-based non-volatile memory media includes at least penta-level cells.
